(19) United States
(12) Patent Application Publication
(10) Pub. No.: US 2010/0181405 A1
(43) Pub. Date: Jul. 22, 2010

(54) BLADE ASSEMBLY FOR SHREDDERS OF SHEET-LIKE MATERIAL

(75) Inventors: Norman Bouwhuis, Bentonville, AR (US); Josh Davis, Hudson, OH (US)

Correspondence Address: FAY SHARPE LLP, 1228 Euclid Avenue, 5th Floor, The Halle Building, Cleveland, OH, 44115, US

(73) Assignee: ROYAL APPLIANCE MFG. CO.D/B/A TTI FLOOR CARE NORTH AMERICA

(21) Appl. No.: 12/649,763

(22) Filed: Dec. 30, 2009

Related U.S. Application Data
(60) Provisional application No. 61/142,579, filed on Jan. 5, 2009.

(51) Int. Cl. B02C 18/18; B02C 18/16

(52) U.S. Cl. 241/236; 241/243; 241/292.1

(57) ABSTRACT

A shredder device includes a curvilinear formation formed from an offset alignment of cutter teeth for the discs connected to a shaft. The offset alignment is from about 10-degrees to about 40-degrees in a first circumferential direction for a first length portion of the formation and from about 10-degrees to about 40-degrees in a second circumferential direction for a second length portion of the formation such that a vertex is formed at one point along the formation.

This application claims the benefit of priority to U.S. Provisional Patent Application No. 61/142,579, filed Jan. 5, 2009, entitled “BLADE ASSEMBLY FOR SHREDDERS OF SHEET-LIKE MATERIAL”, by Josh Davis, et al., the disclosure of which is hereby incorporated by reference in its entirety.

### BACKGROUND

The present disclosure is directed toward an offset non-linear cutter blade pattern extending along a surface of a cutter shaft and, more specifically, to a cutter blade pattern incorporated on a cutter shaft that shreds at least one generally planar sheet of media.

It is advisable to destroy information carrying media, such as, for example, paper documents, compact discs (CDs), digital video discs (DVDs), and plastic credit cards, to lessen a risk of misappropriation of confidential information. Media shredder devices are widely used by persons seeking to alleviate these privacy concerns. Media shredder devices were once customarily used in government enterprises; however, later devices were introduced for small office and household environments. These later devices are suited for shredding media on a non-industrial scale. A first type of shredder device shreds generally planar media into a plurality of elongate strips. For more sensitive media, a smaller shred size is achieved with a second type of shredder device, which cross-cuts the elongate strips into a plurality of fragments. As a matter of preference, the protection approach of the cross-cut type shredder device is preferred for certain applications in which elongate strips can be reassembled to display original matter. A further advantage of the cross-cut type shredder over the strip-cut type shredder is a reduction in clogging or bunching that result in jams caused by flexible, elongate strips that wind around a cutting cylinder.

To achieve a cross-cut in media, a shredder device generally includes a pair of parallel cutting cylinders, wherein at least one cylinder includes a plurality of offset cutter blades arranged along an axis thereof. Each of the offset cutter blades is included on respective cutter discs, which are adjacently disposed along the shaft in spaced apart relationship. The cutter blades of a plurality of cutter discs are offset to produce a generally linear helical pattern, shown in FIG. 7, over a circumferential surface of a cutting cylinder. The helical pattern is aimed to even-out the motor and gear loads while at least one generally planar media material is fed between the cutting cylinders.

One aspect of the offset helical blade pattern is a tendency for the media to walk toward one longitudinally extending side portion of the cutting cylinders. Media that walks toward the side portion can start to bunch up in a throat of the shredder device. A quality of the cut made to the bunched up media can be compromised. More specifically, the shreds at the side portion come out as one elongate cut instead of multiple cross-cuts.

Another aspect of the offset helical blade pattern is a tendency for the media walking toward the one side portion to fold over, wherein the folded over portion can catch between the most distal one of the cutter discs and the core mount structure rotatably supporting the cutter cylinders. If the folded over portion gets trapped between the disc and the mount structure, a clog or a jam can temporarily disable the device. In instances when no jamming occurs, the shredder device is forced to shred media of a different thickness at the folded over portion. This varied thickness draws more amps on the motor, and the cuts at this folded over portion tend to be in the form of strips.

A shredder is therefore desirable which includes at least one cutter shaft that offset the cutter blades in a pattern that prevents the media from walking. More specifically, a pattern is desired that maintains the media at a center length portion of the cutting cylinders as it moves between the cutting cylinders.

### BRIEF DESCRIPTION

A first embodiment of the disclosure is directed toward a head assembly for a media shredder. The head assembly includes motor drive assembly, a media feed slot, and a pair of counter-rotating cutter shafts. The media feed slot is dimensioned to receive at least one generally planar sheet of media. Blades protruding outward from discs connected to cutter shafts shred the media into strips or fragments of chad. At least one of the shafts includes multiple cutter discs spaced apart along at least a length portion of the cutter shaft, wherein adjacent cutter discs are oriented to include an outermost and an innermost disc. Each cutter disc includes multiple teeth. A tooth on an outer disc is offset an angle from a corresponding tooth on an adjacent inner disc. Each corresponding tooth on the adjacent discs extending inwardly from a first terminal end of the length portion end is offset a first angle and each corresponding tooth on the adjacent discs extending inwardly from a second terminal end is offset a second angle in a same circumferential direction.

A second embodiment of the disclosure is directed toward a cutter shaft assembly. The cutter shaft assembly includes a first cutter shaft having spaced cutter discs along a length portion of the cutter shaft and a second cutter shaft including spaced cutter discs along an equivalent length portion of the cutter shaft. The cutter discs of the first shaft alternate in longitudinal alignment with the cutter discs of the second shaft when the cutter discs pass between the first and the second cutter shafts. The cutter shaft assembly further includes multiple cutter teeth on each of the cutter discs. Each cutter tooth on a cutter disc is angularly offset from a corresponding cutter tooth on an adjacent cutter disc such that corresponding cutter teeth for all cutter discs on a same shaft form a generally non-linear formation. The cutter shaft assembly is incorporated in a media shredder device for shredding generally planar media into strips or fragmented strips of chad.

A third embodiment of the disclosure is directed toward a media shredder device for shredding media. The media shredder device includes a bin having a containment space for collection of shredded media and a head assembly generally situated adjacent to the bin. The head assembly includes a core mount supporting a motor assembly and a cutter assembly. The cutter assembly includes a pair of cutter shafts. Each cutter shaft includes a plurality of longitudinally spaced apart cutter discs having a plurality of circumferentially spaced apart teeth jetting outwardly therefrom. A curvilinear formation is formed from an offset alignment of the cutter teeth for the discs connected to each shaft. The offset alignment is from about 10-degrees to about 40-degrees in a first circumferential direction for a first length portion of the formation and the offset alignment is from about 10-degrees to about 40-degrees in a second, opposite circumferential direction for a second length portion of the formation such that a vertex is formed at one point along the formation.

A fourth embodiment of the disclosure is directed toward a cutter shaft for incorporation in an appliance for dividing a material into multiple, fragmented parts. The cutter shaft includes a plurality of spaced apart cutter discs longitudinally disposed along a length portion of the shaft. Each cutter disc includes a generally smooth circumferential surface. A plurality of teeth is circumferentially disposed along the circumferential surface of at least one of the cutter discs. The teeth protrude outwardly from the smooth circumferential surface and are spaced apart by a circumferential surface portion. A plurality of non-linear formations is formed from an offset alignment of corresponding cutter teeth on adjacent cutter discs. One of the non-linear formations includes an offset alignment of the corresponding teeth in a first circumferential direction for at least a first length portion of the cutter shaft and an offset alignment of the corresponding teeth in a second circumferential direction for at least a second length portion of the cutter shaft. The plurality of teeth on each cutter disc is spaced a circumferential distance that provides for at least one tooth included on every other formation to coincide on a shared, longitudinally extending line.

### BRIEF DESCRIPTION OF THE DRAWINGS

FIG. 1 illustrates a top view of a head assembly incorporating a cutter shaft according to one embodiment of the disclosure;

FIG. 2 illustrates a perspective view of a cutter disc including on a cutter shaft of the disclosure;

FIG. 3 illustrates top still-shot view of a formation incorporated on a cutting cylinder according to a first embodiment of the disclosure;

FIG. 4 illustrates a top still-shot view of a formation incorporated on a cutting cylinder according a second embodiment of the disclosure;

FIG. 5 illustrates a top still-shot view of a formation incorporated on a cutting cylinder according to a third embodiment of the disclosure;

FIG. 6 illustrates a top still-shot view of a formation incorporated on a cutting cylinder according to a fourth embodiment of the disclosure;

FIG. 7 illustrates a perspective view of a known cutting cylinder incorporating a linear helical formation;

FIG. 8 illustrates a top still-shot view of a first orientation of the formation shown in FIG. 5 incorporated on a pair of cutting cylinders;

FIG. 9 illustrates a top still-shot view of a second orientation of the formation shown in FIG. 5 incorporated on a pair of cutting cylinders;

FIG. 10 illustrates a top still-shot view of a third orientation of the formation shown in FIG. 5 incorporated on a pair of cutting cylinders; and,

FIG. 11 illustrates a destroying device incorporating the cutter shaft formation embodiments of the disclosure.

### DETAILED DESCRIPTION

The present disclosure is directed toward an offset cutter blade configuration incorporated on a cutter shaft. More specifically, the offset cutter blade configuration is disclosed herein for incorporation on a cutter shaft (herein synonymously referred to as “cutting cylinder or cutter cylinder”) utilized in a destroying device. The device is anticipated for destroying at least one (uni-)body of material into multiple smaller bodies. In one disclosed embodiment, the device is a media shredder that shreds at least one article of media, which may be a generally planar sheet of media. Media may be contemplated as including at least paper (documents), plastic (cards), and metallic (storage discs) materials. A generally planar sheet of media is contemplated as including a first surface opposite a second surface and having a generally minimal relative thickness. Variable thickness herein, however, means an overall thickness of the at least one media sheet being fed. In other words, the variable thickness is the combined thickness of all (a stack of at least one) media sheets fed simultaneously toward the at least one cutter shaft.

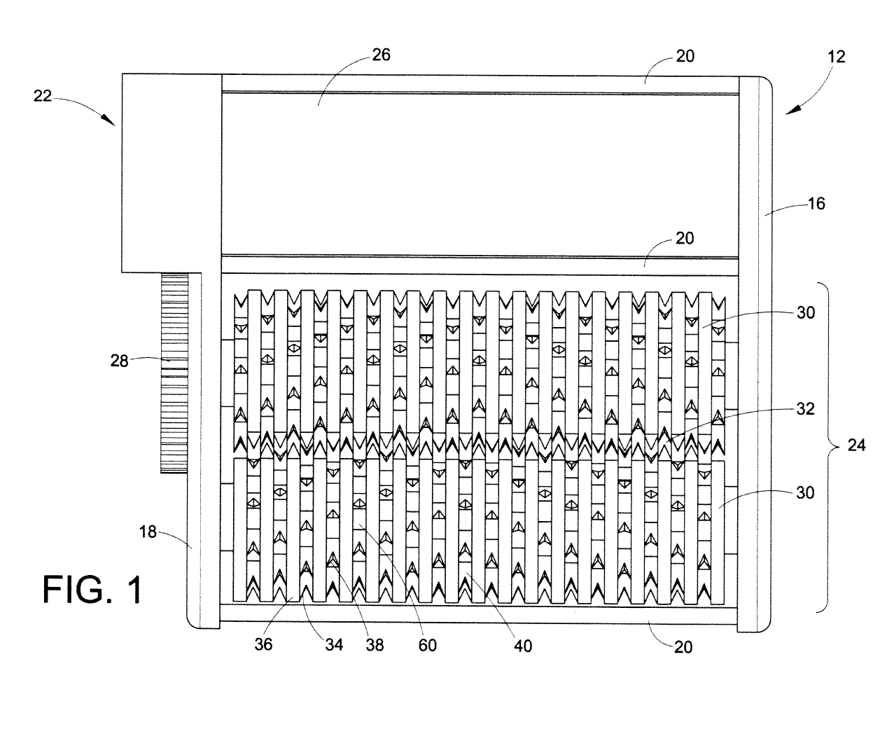

FIG. 1 illustrates a top view of a head assembly 12 for a media shredder. The head assembly 12 is illustrated to include a core mount assembly 14 formed of a first support member 16 opposite a second support member 18. The first and second support members 16, 18 can comprise a wall having a generally first planar face (hereinafter synonymously referred to as “surface”) opposite a generally second planar face. The support members 16, 18 can alternately comprise elongate bars having at least a generally planar face or surface at the inward orientation. The core assembly 14 can further include at least one fixed third support member 20 situated between and transient to the first and second support members 16, 18. The third support member 20 is shown in the illustration as a rod; however, a generally planar wall and other support structures are contemplated. In one embodiment, three generally parallel rods 20 connect the first support member 16 to the second support member 18. These rods 20 also segment a compartment containing a locomotive device 22 (hereinafter synonymously referred to as “motor assembly”), which is spaced apart from a cutter assembly 24. The head assembly 12 includes the locomotive device 22, which drives the later described cutter assembly 24. The locomotive device 22 can include any known drive assembly. In one particular embodiment, the locomotive device 22 as illustrated in FIG. 1 includes a motor 26 and one or more gears 28. The gears 28 drives rotation of at the cutting assembly 24 in forward and/or reverse directions. The cutting assembly 24 includes at least one elongate cutting shaft 30. The cutting assembly 24 is illustrated to include two elongate cutting shafts 30 situated in parallel relationship that defines a feed gap 32 (i.e., a feed slot portion) formed between the innermost adjacent circumferential surfaces of the cutter shafts 30. Each of the two cutting shafts 30 is rotatably mounted at terminal ends to the first and second support surfaces 16, 18. In one embodiment, a set of combs or tines (not shown) can extend inwardly from the third support surfaces 30 toward the cutting cylinder(s) 30. In one contemplated embodiment, only one cutting cylinder 30 can be incorporated work in conjunction with one set of combs to achieve a destroying of the media fed into the device.

At least one of the cutting cylinders 30 includes a plurality of spaced apart cutter discs 34. The cutter discs 34 are illustrated in FIG. 1 to be situated in alternating fashion with spacer discs 36. The spacer discs 36 prevent fragments of media from collecting in the spaces between the cutter discs 34. As is illustrated in the figure, at least a portion of each cutter disc 34, referred to as cutter blades below, reaches beyond a diameter of the spacer disc 36 and into the feed gap 32 formed between the cutting cylinders 30 as the cutting cylinders rotate.

The cutter discs 34 include a plurality of spaced apart cutter blades 38. Each cutter blade (hereinafter synonymously referred to as “tooth”) extends outwardly from a circumferential surface of the cutter disc 30. Hereinafter, the combined circumferential surfaces of the multiple cutter discs 30 are collectively referred to as the circumferential surface 40 of the cutting cylinder 30.

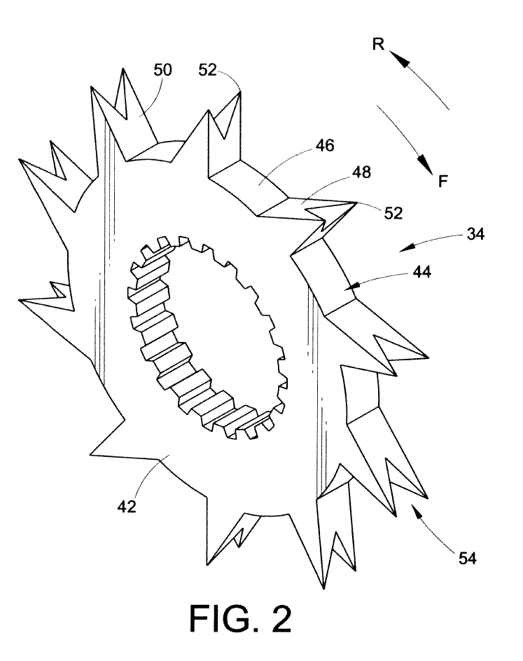

FIG. 2 illustrates a cutter disc 34 utilized in shredding planar media into multiple cross-cuts. The cutter disc 34 includes a first planar disc surface 42 opposite a second planar disc surface 44 and a circumferential disc surface 46 generally transient thereto and connecting the disc surfaces. Each tooth 38 jets angularly outward from the circumferential disc surface 46. The angled orientation is formed by a long edge 48 and a short edge 50 that meet at a cutting edge 52 (shown in phantom). The cutting edge 52 of each tooth is directed downwardly through the feed gap 32 (FIG. 1) when the cutter disc 34 is driven in forward rotation. In this manner, the cutting edge 54 will puncture the media and destroy the media as it is fed downwardly through the feed gap 32 (FIG. 1); however, media driven upwardly through the feed gap, when the cutting cylinder(s) 30 is operated in reverse rotation, will simply glide against the long edge of the tooth 38. In this manner, the media can be retrieved for reinsertion into the feed slot in instances such as jams.

As is illustrated in FIG. 2, the teeth 38 can include an inward triangular indentation 54′ at the cutting edge 52. The triangular indentation 54′ forms two spaced points 56 in the cutting edge 52. These points 56 furthermore assist the blade in puncturing the media. This disclosure, however, is not limited to the illustrated cutter disc 34; rather, any cutter disc or tooth configuration may be incorporated that is capable of piercing and destroying media passing through or against a rotating cylinder 30 as is contemplated for use with the present disclosure.

In one embodiment, the placement of successive cutter discs 34 on the shaft 30 results in an orientation or formation 60 of teeth 38. The cutter discs 34 are connected to the shaft 30 in such a manner (orientation) that their respective teeth 38 form longitudinally extending formations on the cutter shaft 30. More specifically, the cutter discs 34 are connected to the cutting shaft 30 such that they rotate in unison with the shaft. Therefore, any offset alignment between the teeth 38 of two successive or adjacent discs remains constant after the discs 34 are connected to the shaft 30. More specifically, any offset alignment between proximately positioned teeth 38 of successive cutter discs 30 is maintained throughout an entire rotation(s) of the cutter shaft 30. It is anticipated that the formations disclosed herein are formed on the cutter shaft 30 during an assembly phase of the present cutting cylinder 30, wherein the formations are formed by a specific arrangement of the cutter discs 34 as they are connected to the cutting shaft 30. Formations 30 are formed by an arrangement of cutter discs 34 on the shaft 30 when at least one blade 38 on each successive disc 34 is utilized as a reference for connection. This one blade 38 is offset a desired circumferential distance from the blades 38 included on of at least one adjacent disc 38.

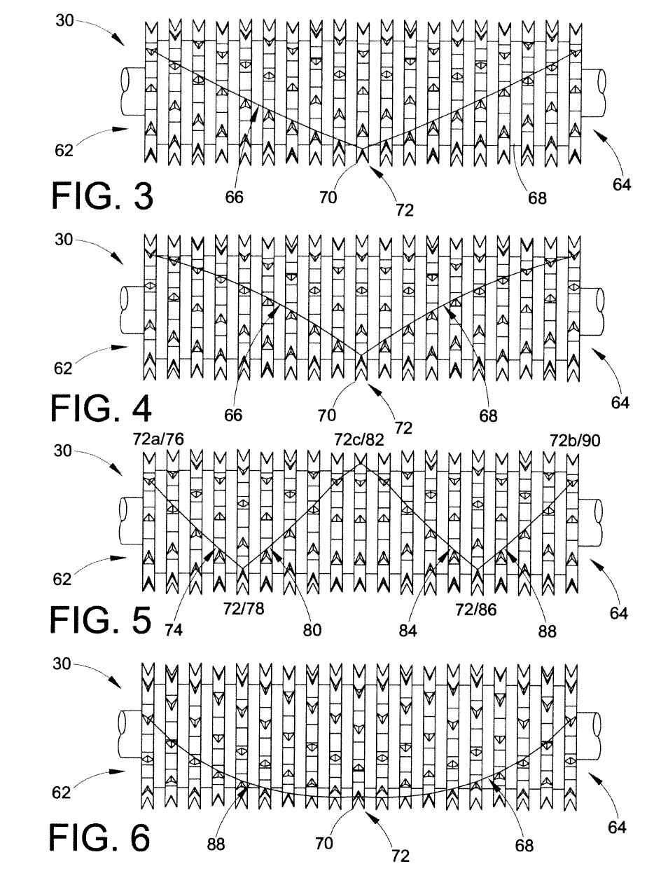

In one embodiment, the longitudinally extending formations 60 may be parallel based on the circumferential surface portion 58 between each tooth 38 on any one cutter disc 34 being an even distance. In one embodiment, the formation 60 is a non-linear formation or a curvilinear formation extending from a first terminal (outermost) end 62 of the cutting cylinder to a second terminal (outermost) end 64 of the cutting cylinder 30. FIGS. 3-6 illustrate a top view of the cutting assembly including a plurality of non-linear formations on each cutting cylinder. The non-linear formations 60 are achieved by situating the blades 38 in proximity to one another (hereinafter referred to as “corresponding blades”) on adjacent cutting discs 34 in an offset alignment when connecting each cutting disc 34 to the cutting shaft 30. Therefore, each blade 38 is rotationally offset from the corresponding blade on the at least one adjacent cutting disc 34. In one embodiment, the degree of offset is greater than zero between each corresponding tooth. In another embodiment, the degree of offset is greater than zero for each corresponding tooth situated along at least one longitudinally extending portion of the formation 60.

The formation in FIGS. 3, 4, and 6 is illustrated as including a first formation portion 66 having teeth 38 in offset alignment in a first circumferential direction and a second formation 68 portion having teeth in offset alignment in a second, opposite circumferential direction. In one embodiment, each corresponding tooth 38 on the adjacent cutter discs 34 extending inwardly from the first terminal end 62 of the cutting shaft 30 is offset a first angle in a circumferential direction and each corresponding tooth on the adjacent discs 34 extending inwardly from a second terminal end 64 is offset a second angle in a same circumferential direction. In one embodiment, the circumferential direction is associated with a direction corresponding to a forward rotation of the cutting cylinders 30. In one embodiment, the circumferential direction is associated with a direction corresponding to a reverse rotation of the cutting cylinders 30. The first angle is from about 10-degrees to about 70 degrees and, more preferably, from about 10-degrees to about 40-degrees. The second angle is from about 290-degrees to about 350-degrees and, more specifically from about 320-degrees to about 350-degrees. In this manner, the formation portions 66, 68 formed from corresponding teeth extending inwardly from both terminal ends will intersect. In this embodiment, the formation portions 66, 68 only extend until the point of intersection, wherein a vertex 70 is more specifically formed at the formation 60.

The first and second angles of offset between each adjacent corresponding blade 38 can be constant or variable throughout the longitudinal extent of the cutter cylinder 30. In embodiments where the first angle of offset is a constant degree and the second angle of offset is a constant degree, the vertex is a sharp, defined point and the formation 60 is representative of a V-shape (FIG. 3) or a check-mark symbol (not shown). The formation 60 can similarly be a V-shape or a check-mark symbol shape in embodiments where the first and second angles of offset are not constant. FIG. 4 illustrates a V-shaped formation 60 utilizing offset angles that are not constant throughout the formation 60. In this embodiment, the first angle and the second angle increase to greater degrees as the formation 60 moves inwardly from the terminal ends 62, 64 of the cutting cylinder 30. This increase provides for a shallower formation portion at the terminal ends 62, 64 and a steep formation portion in proximity to the vertex 70. In embodiments where the first angle of offset is equal to the second angle of offset for each pair of corresponding teeth 38 removed a same distance away from opposing terminal ends 62, 64 of the cutting cylinder 30, the formation 60 is symmetric in appearance, as is shown in FIGS. 3-6. Therefore, the vertex 70 is formed at a center (innermost) midpoint of the longitudinal length portion. However, the vertex 70 can be situated at the center midpoint in unsymmetrical embodiments (not shown) as well. For example, the first angle can be constant and the second angle variable, but the overall point of intersection for the inwardly extending formation portions can fall at the midpoint.

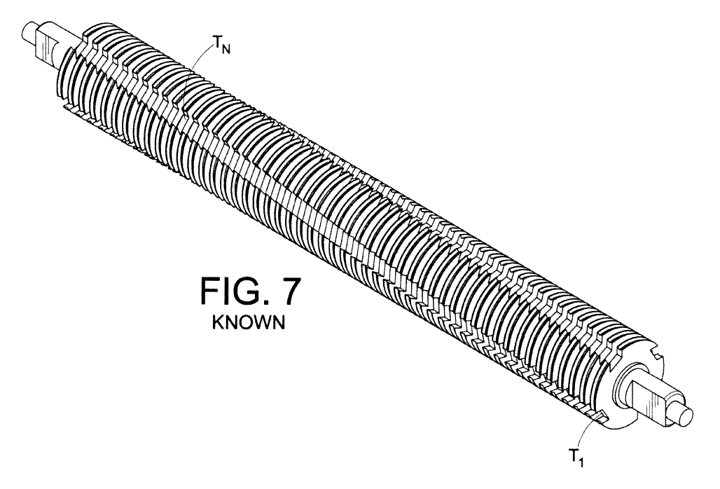

One aspect that the symmetrical formations 60 of FIGS. 3-6 provide the present cutting cylinder 30 the function of maintaining a centered feeding of the generally planar media. Known helical formations that are generally defined by a constant degree of offset in one circumferential direction across an entire longitudinal extent of a cutting shaft. One known helical formation is shown in FIG. 7. Formations of this type can tend to walk the media toward one side portion or one terminal end portion of a throat or a feed path situated adjacent to the feed gap. The media can tend to bunch up or fold over. Folded over media changes a variable thickness of the at least one media being fed into the shredder. In other words, the variable thickness is not uniform for the entire length portion of media simultaneously fed between the cutter cylinders. Therefore, the quality of the shred cut is compromised for the media fed between the cutting cylinders situated in proximity to the bunched or folded media. The additional draw on the motor assembly can tend to cause the bunched up or folded over media to be cut in elongate strips while the planar media portion at the other end of the feed path is cut in a plurality of cross-cuts.

Generally, the most forward oriented tooth situated on a circumferential surface of the cutting cylinder is the tooth that grabs the media. The most forward oriented tooth T₁ included on a helical formation of known cutting cylinders is the most terminal tooth. This tooth is included on the cutter disc at the most terminal end of the cutting cylinder. Therefore, the media sheet is grabbed at its lowest corner portion. Generally, each subsequent tooth T_{N} adjacent to the most forward oriented tooth is angularly offset a circumferential degree to assist in pulling the at least one media sheet through the feed path and between the cutting cylinders. Because the media sheet was grabbed at its corner, the media sheet is pulled considerably at its one side before the other side is even grabbed. Therefore, it tends to bunch.

The present disclosure is related to formations 60 which include a most forward oriented tooth 72 situated inwardly from terminal ends 62, 64 of the cutting cylinder (FIG. 3). In one embodiment, the most forward oriented tooth 72 is situated at the midpoint along the length of the cutting cylinder 30. In this manner, a media sheet being fed into the feed gap 32 (FIG. 1) is grabbed at a center portion of its lower edge. In another embodiment, shown in FIG. 5, two forward teeth 72 are situated at the most forward oriented region on the circumferential surface of the cutting cylinder for each formation 60. These two teeth 72, in a symmetric embodiment, are situated at a one-quarter (¼) length portion along the cutting cylinder 30 and a three-quarters (¾) length portion along the cutting cylinder 30.

In another embodiment, the most forward oriented tooth 72 can be situated on the most terminal cutter disc 34 (see FIG. 9); however, a second most forward oriented tooth is also situated on a cutter disc at the opposite terminal end 64 of the cutting cylinder 30 to ensure that the media is pulled evenly through the feed gap 32 (FIG. 1). These two teeth 72 are situated on a longitudinal line L formed across the cutting cylinder 30. In yet another embodiment, three teeth can all share a most forward oriented longitudinal line L formed across the cutting cylinder 30: a first tooth 72a on a disc situated at the first terminal end 62 of the cutter shaft 30; a second tooth 72b on a disc situated at the opposite terminal end 64 of the cutter shaft 30; and, a third tooth 72c situated at the mid-point of the cutter shaft 30. Such an arrangement is shown in the inverse of the cutting cylinder 30 in FIG. 5.

In symmetric embodiments including multiple forward oriented teeth 72 (see, e.g., FIG. 5), a first formation portion 66 extends from a first tooth 76 situated at a first terminal end 62 of the cutting shaft 30 to a second tooth 78 situated at a one-quarter longitudinal length portion. A second formation portion 80 then extends from the second tooth 78 to a third tooth 82 situated at a mid-longitudinal length portion of the cutting cylinder 30. A third formation portion 84 then extends from the third tooth 82 to a fourth tooth 86 situated at a three-quarters longitudinal length portion of the cutting cylinder 30. A fourth formation portion 88 then extends from the fourth tooth 86 to a fifth tooth 90 situated at the second terminal end 64 of the cutting cylinder 30. The teeth 38 of the first and third formations 74, 84 are offset angularly in a first circumferential direction while the teeth 38 of the second and fourth formations 80, 88 are offset angularly in second, opposite circumferential direction. The first circumferential direction can be associated with a direction of forward rotation while the second offset direction can be associated with a direction of reverse rotation. The first circumferential direction can be associated with a direction of reverse rotation while the second offset direction can be associated with a direction of forward rotation. Other embodiments are contemplated to include at least three teeth 38 situated on the most forward oriented line, wherein a plurality of V-shapes are included in one formation along the cutting cylinder. In these embodiments, each formation portion extends a fraction of the overall length of the cutting cylinder 30. There is no limitation made herein to a length along the cylinder (i.e., fraction) of each formation portion. There is furthermore no limitation made herein to the number of repeat formation portions (such as, for example, repeat V-shapes) along a longitudinal extent of a formation 60.

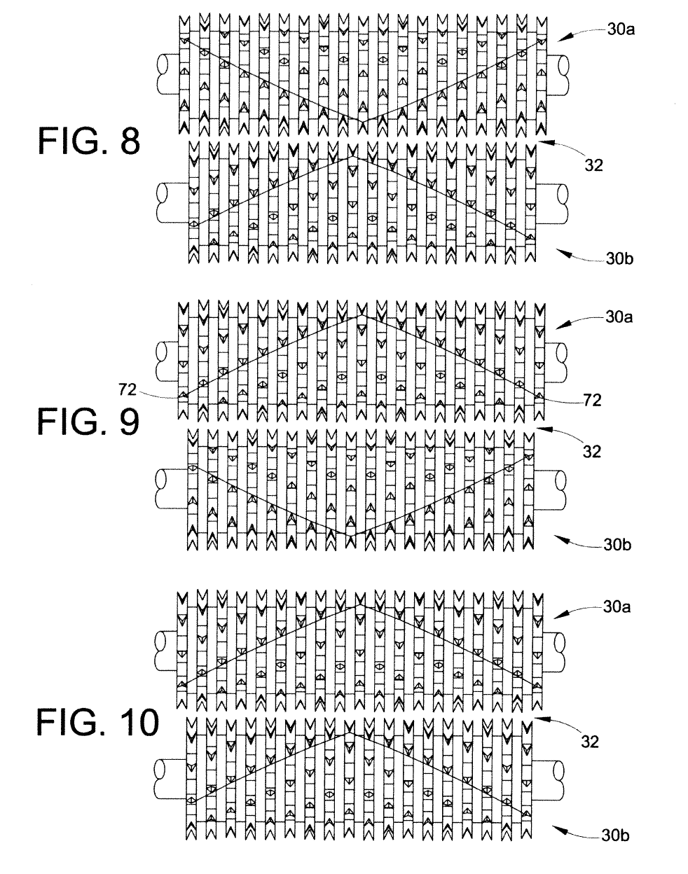

In one embodiment, the cutter shaft 30 is oriented such that at least one vertex tooth 70 is situated at the midpoint of each formation 60 and is at the most forward point for any line on the circumferential surface 40. In this manner, the cutter shaft 30 is oriented such that the vertex 70 points downwardly at a plane extending generally coincident with a longitudinal centerline of the feed gap 32 (see FIG. 8) when the cutter shaft 30 is rotated (hereinafter referred to as “V-shape”). In one embodiment, the cutter shaft 30 is oriented such at a vertex tooth 70 is situated at the midpoint of each formation and is at the most rearward line on the circumferential surface 40 (see FIG. 9). In this manner, the cutter shaft 30 is oriented such that the vertex 70 points upwardly at a plane extending generally coincident with a longitudinal centerline of the feed gap 32 when the cutter shaft 30 is rotated (hereinafter referred to as “inverse V-shape”). In this embodiment, the most forward teeth 72 that grab the media are situated at the terminal ends 62, 64 of the cutter cylinder 30.

It is anticipated that the formations 30 on one cutting cylinder 30 can work in conjunction with formations on an adjacent parallel extending cutting cylinder 30, as is illustrated in FIGS. 8-10. In one embodiment, the formations 60 on both cutting cylinders 30 are non-linear and identical in appearance and shape. In one embodiment (not shown), the formations 60 on both cutting cylinders 30 are non-linear but not identical in shape and appearance. In one embodiment (not shown), the formations 60 on the first cutting cylinder 30 are non-linear while the formations 60 on the second cutting cylinder 30 and generally linear.

In the two-cylinder embodiments of FIGS. 8-10 having identical non-linear formations, the orientations can vary for the formations 60 when the cylinders rotate in counter clockwise directions adjacent to one another. In the embodiment of FIG. 8, the formations 60 on both cutting cylinders 30a, 30b are oriented as V-shaped such that the adjacent formations 60 of the two cutting cylinders 30 form a general X-shape. In the embodiment of FIG. 9, the formations 60 on both cylinders 30a, 30b are oriented as inverse V-shaped such that the adjacent formations 60 of the two cutting cylinders 30 form a general diamond shape. In these two embodiments, the formations 60 appear generally symmetric at opposing sides defining the feed gap 32. Although the spaced apart cutter discs 34 are situated along equivalent length portions of the adjacent cutting cylinders 30, the formations 60 are not completely symmetric because the teeth 38 of the first cutting cylinder 30a extending into the feed gap 32 are interleaved (i.e., interdigitated) with the teeth 38 of the second cutter cylinder 30b extending into the feed gap. In other words, the cutter discs 34 of the first cutter shaft 30a alternate in longitudinal alignment with the cutter discs 34 of the second cutter shaft 30b when corresponding regions of the cutter discs 34 pass between the pair of cutter shafts 30a, 30b.

In other embodiments, such as the embodiment shown in FIG. 10, the formations 60 of the first cutting cylinder 30a can be oriented as V-shaped while the formations 60 of the adjacent, second cutting cylinder 30b can be oriented as inverse V-shaped. In this manner, the formations 60 appear generally parallel at opposing sides defining the feed gap 32. The vertex 70 of the formation on the first shaft 30a is pointed outwardly relative to the feed gap 32 and the vertex 70 of the formation on the second shaft 30b is pointed inwardly relative to the feed slot 32.

Similar symmetric and parallel formations can be achieved between a pair of cutting cylinders 30 including curvilinear formations not having a sharp, defined vertex 70 point. Formations 60 for a cutting cylinder 30 are also contemplated for, but not limited to, parabolic embodiments, concave-shaped embodiments, and convex-shaped embodiments (see FIG. 6). A vertex 70 for a concave or a convex shaped embodiment can include one tooth 28 at a crest (similar to a vertex) of each formation 60; however, the offset angles between adjacent corresponding cutter teeth 38 situated on the cutter discs 34 proximate to terminal ends 62, 64 of the cutting cylinder 30 are greater degrees than the offset angles between adjacent corresponding cutter teeth 38 situated on the cutter discs 34 proximate to the middle-length portion of the cutting cylinder 30.

Embodiments (not shown) are also contemplated to include two cutting cylinders 30a, 30b, wherein the first cutting cylinder 30 includes non-linear formations of a parabolic, concave, or convex shape (see FIG. 9) and the second cutting cylinder 30b includes non-linear formations 60 of a V- (see FIGS. 3-5), inverse V-, or check-mark symbol shape. Furthermore, embodiments (not shown) are contemplated in which a cutting cylinder 30 includes two types of non-linear formations 60 extending along its circumferential surface 40, wherein generally parallel parabolic, concave, or convex shaped formations alternate between generally parallel V-, inverse V-, or check-mark formations. Spacing 58 between teeth 38 on each cutter disc 34 would vary for these embodiments. More specifically, the spacing 58 between the teeth 38 would not be uniform along the entire circumferential surface 40.

In the disclosed embodiment, the spacing 58 between all the teeth 38 is generally equal along the circumferential surface 40. The equal spacing 58 (i.e., the equal circumferential surface portions) cause all the formations 60 to be parallel to each other if all the cutter discs 34 used across the entire longitudinal extent of the cutting cylinder 30 are identical. The length of the circumferential surface portions 58 influence the shred or the destruction size made to media. This length portion, independently or taken in conjunction with the width of each spacer disc 36 (FIG. 1), can influence the number of teeth 38 included on the formation 60 that are coincident to points on a shared longitudinal line L extending across the cutter cylinder 30. In one embodiment, the spacing 58 between the multiple teeth 38 on the cutter disc 30 is such that a circumferential distance between a first tooth forming a vertex 70 of a formation 60 and an adjacent tooth on the cutter disc 34 (i.e., the spacing 58) is less than a circumferential distance between the first tooth and a third, terminal tooth (i.e., third tooth on a terminal disc) of the formation 60. In this manner, the most forward oriented tooth of a formation 60 grabs the media during rotation before the most rearward oriented tooth of the previous formation releases the media. In other words, a constant grip is maintained on the media following the initial grabbing of such media at the lower edge when the media is first introduced into the feed gap 32.

Once the media is introduced in the feed gap 32, it is anticipated that at least one tooth 38 on the cutting cylinder 30 (or on the both of two, parallel cylinders) is in contact with the media until the media moves entirely through the feed gap 32. In one embodiment, the spacing 58 between the multiple teeth 38 on each cutter disc 34 is equivalent to a circumferential distance that causes at least one tooth from only every other of the parallel formations 60 to coincide on a shared longitudinally extending line L formed on the cutter shaft 30. In this manner, the number of teeth 38 entering the feed gap 32 at any one time is not too great. One advantage associated with having the teeth 38 from every other formation 60 sharing a longitudinally extending line L is that the feed path is not too congested when the line L is situated within the feed gap 32, yet there still exist a sufficient number of multiple teeth 38 travelling through the feed gap 32 for achieving a small shred size. The present disclosure is not limited, however, to any number of teeth from parallel formations sharing a longitudinal line. At least one tooth from every formation can be situated on a longitudinal line. At least one tooth from a pair of two or more adjacent formations can be situated on a longitudinal line. There is no limitation made herein to such arrangements.

FIG. 1 illustrates this alternating formation 60 embodiment being achieved by having at least one tooth 38 from every third disc 34 being situated on the same formation 60. Depending on an angle of offset, at least one tooth 38 from every disc 34 or from every other disc 34 can also be included in the same formations 60. There is no limitation made herein to the general steepness of parallel formations.

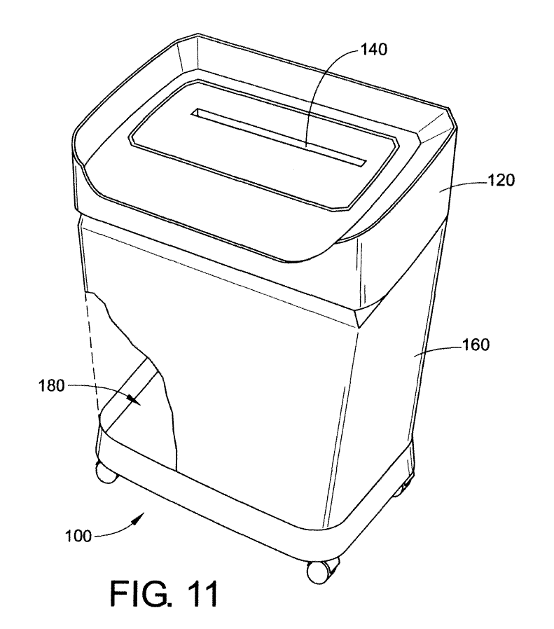

It is anticipated that at least one cutting cylinder 30 having teeth in a staggered relationship can be utilized in a destroying device. It is anticipated that the at least one cutting cylinder 30 can be utilized in conjunction with a second, parallel cutting cylinder (as is shown in FIGS. 1 and 8-10). This device can be an appliance for dividing material into multiple, fragmented parts. In one embodiment, at least one cutting cylinder 30 can be incorporated in a head assembly for a destroying device. The destroying device can be the media shredder 100 shown in FIG. 11, wherein the head assembly 120 can include a media feed slot 140 dimensioned for receipt of the at least generally planar sheet of media. The cutter cylinder(s) can be incorporated in the media shredder device 100 for shredding the generally planar media into strips or fragments of chad. The media shredder device 100 further includes a bin 160 having a containment space 180 for collection of the shredded media. The head assembly 120 is situated adjacent to the bin 160. The head assembly 120 houses the core mount and the cutter assembly shown in FIG. 1, wherein media fed through the feed slot 140 is shredded as it travels through the feed gap 32 (FIG. 1) between the cylinders 30. The shreds then fall into the bin 160, where the shreds are collected until they are subsequently emptied into a trash receptacle.

Because shredder devices aim to preserve privacy, it is necessary that the media is shred into fragments having a size that prevents matter portions printed thereon from being readable. The width of the spacer discs, the spacing between blades, and the width of the cutter discs all influence the shred size. The present formations for cutting cylinders disclosed herein are anticipated for use in shredder devices utilizing cutting cylinders having a length within a range of from about 216 mm to about 245 mm and diameters within a range of from about 25 mm to about 50 mm. A distance between the teeth is approximately from about 10 mm to about 45 mm. This distance correlates to the chad (shred) size. Furthermore, it is anticipated that a throat opening (i.e., feed slot) to the cutting cylinder(s) for the media shredder include a length (i.e., depth) of from about 216 mm to about 240 mm. For cutting assemblies utilizing two parallel cutter discs, it is anticipated that a distance between adjacent surfaces of the discs (i.e., a width formed between the cutting cylinders) ranges from about 2 mm to about 4.5 mm.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A head assembly for a media shredder, comprising:
a motor drive assembly;
a media feed slot dimensioned for receipt of at least one associated generally planar sheet of media; and,
a pair of counter-rotating cutter shafts for shredding the associated media into strips and fragments of chad, at least one shaft including:
multiple cutter discs spaced apart along at least a length portion of the cutter shaft, wherein adjacent cutter discs are oriented to include an outermost and an innermost disc, and
multiple teeth on each cutter disc;
wherein a tooth on an outer disc is offset an angle from a corresponding tooth on an adjacent inner disc;
wherein each corresponding tooth on the adjacent discs extending inwardly from a first terminal end of the length portion end is offset a first angle and each corresponding tooth on the adjacent discs extending inwardly from a second terminal end is offset a second angle in a same circumferential direction.

2. The head assembly of claim 1, wherein the first angle is from about 10-degrees to about 40-degrees, and the second angle is from about 320-degrees to about 350-degrees; wherein corresponding teeth of all cutter discs on the cutter shaft form a non-linear formation.

3. The head assembly of claim 2, wherein each adjacent inner tooth is offset from the corresponding outer tooth until a vertex is formed in the non-linear formation.

4. The head assembly of claim 3, wherein the vertex is formed at a center midpoint of the length portion.

5. The head assembly of claim 3, wherein the cutter shaft is oriented such that the vertex points downwardly at a plane extending generally coincident to a longitudinal centerline of the feed slot when the cutter shaft is rotated.

6. The head assembly of claim 3, wherein the cutter shaft is oriented such that the vertex points upwardly at a plane extending generally coincident to a longitudinal centerline of the feed slot when the cutter shaft is rotated.

7. The head assembly of claim 3, wherein spacing between the multiple teeth on the cutter disc is such that a circumferential distance between a first tooth forming a vertex of a formation and an adjacent tooth on the cutter disc is less than a circumferential distance between the first tooth and a third, terminal tooth of the formation.

8. The head assembly of claim 3, wherein spacing between the multiple teeth on the cutter disc is a circumferential distance that causes at least one tooth from only every other formation to situate coincident on a shared longitudinally extending line formed on the cutter shaft.

9. The head assembly of claim 1, wherein the cutter discs of the first cutter shaft alternate in longitudinal alignment with the cutter discs of the second cutter shaft when the cutter discs pass between the pair of cutter shafts.

10. A cutter shaft assembly, comprising:
a first cutter shaft including spaced cutter discs along a length portion of the cutter shaft;
a second cutter shaft including spaced cutter discs along an equivalent length portion of the cutter shaft, the cutter discs of the first shaft alternating in longitudinal alignment with the cutter discs of the second shaft when the cutter discs pass between the first and the second cutter shafts;
multiple cutter teeth on each of the cutter discs, each cutter tooth on a cutter disc angularly offset from a corresponding cutter tooth on an adjacent cutter disc such that corresponding cutter teeth for all cutter discs on a same shaft form a generally non-linear formation;
wherein the cutter shaft assembly is incorporated in a media shredder device for shredding generally planar media into strips or fragmented strips of chad.

11. The assembly of claim 10, wherein the non-linear formation includes a vertex formed from an intersection of a first formation portion extending inwardly in a circumferential direction from a first terminal end of the shaft and a second formation portion extending inwardly in the same circumferential direction from a second terminal end of the shaft.

12. The assembly of claim 11, wherein the vertex is situated at a longitudinal midpoint of the shaft.

13. The assembly of claim 11, wherein the vertex of the formation is pointed inwardly for each of the first and second shafts relative to a feed slot included on the shredder.

14. The assembly of claim 11, wherein the vertex of the formation is pointed outwardly for each of the first and second shafts relative to a feed slot included on the shredder.

15. The assembly of claim 11, wherein the vertex of the formation on the first shaft is pointed inwardly relative to a feed slot included on the shredder and the vertex of the formation on the second shaft is pointed outwardly relative to the feed slot.

16. The assembly of claim 10, wherein a degree of angular offset between corresponding teeth is from about 10-degrees to about 40-degrees in both circumferential directions.

17. The assembly of claim 10, wherein the non-linear formation includes:
a first formation portion extending from a first tooth situated at a first terminal end of the first and second shafts to second tooth situated at a one-quarter longitudinal length portion of the shaft;
a second formation portion extending from the second tooth to a third tooth situated at a mid-longitudinal length portion of the first and second shafts;
a third formation portion extending from the third tooth to a fourth tooth situated at a three-quarters longitudinal length portion of the first and second shafts; and,
a fourth formation portion extending from the fourth tooth to a firth tooth situated at a second terminal end of the first and second shafts;
wherein the teeth of the first formation are offset angularly in a first circumferential direction, the teeth of the second formation are offset angularly in a second, opposite circumferential direction, the teeth of the third formation are offset angularly in the first circumferential direction, and the teeth of the fourth formation are offset angularly in the second, opposite circumferential direction.

18. A media shredder device for shedding media, comprising:
a bin including a containment space for collection of shredded media;
a head assembly generally situated adjacent the bin and including a core mount supporting a motor assembly and a cutter assembly, the cutter assembly including:
a pair of cutter shafts each including a plurality of longitudinally spaced apart cutter discs having a plurality of circumferentially spaced apart teeth jetting outwardly therefrom,
a curvilinear formation formed from an offset alignment of the cutter teeth for the discs connected to each shaft;
wherein the offset alignment is from about 10-degrees to about 40-degrees in a first circumferential direction for a first length portion of the formation and the offset alignment is from about 10-degrees to about 40-degrees in a second, opposite circumferential direction for a second length portion of the formation such that a vertex is formed at one point along the formation.

19. The media shredder device of claim 18, wherein teeth from at least two parallel formations are situated on a same longitudinal line of a shaft.

20. The media shredder device of claim 18, wherein the vertex of each shaft is pointed inwardly as the motor assembly drives the cutter shafts in a forward direction.

21. A cutter shaft for incorporation in an appliance for dividing an associated article into multiple, associated fragmented parts, comprising:
a plurality of spaced apart cutter discs longitudinally disposed along a length portion of the shaft, each cutter disc includes a generally smooth circumferential surface;
a plurality of teeth circumferentially disposed along the circumferential surface of at least one of the cutter discs, the teeth protruding outwardly from the smooth circumferential surface and spaced apart by a circumferential surface portion;
a plurality of non-linear formations formed from an offset alignment of corresponding cutter teeth on adjacent cutter discs, including:
an offset alignment of the corresponding teeth in a first circumferential direction for at least a first length portion of the cutter shaft, and,
an offset alignment of the corresponding teeth in a second circumferential direction for at least a second length portion of the cutter shaft; and,
wherein the plurality of teeth on each cutter disc is spaced a circumferential distance that provides for at least one tooth included on every other formation coinciding on a shared, longitudinally extending line.
